(19) United States
(12) Patent Application Publication
(10) Pub. No.: US 2004/0267523 A1
(43) Pub. Date: Dec. 30, 2004

(54) Method of reflecting time/language distortion in objective speech quality assessment

(76) Inventor: Doh-Suk Kim, Basking Ridge, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/603,212

(22) Filed: Jun. 25, 2003

(51) Int. Cl. G10L 19/14

(52) U.S. Cl. 704/205

(57) ABSTRACT

A method for objective speech quality assessment that accounts for phonetic contents, speaking styles or individual speaker differences by distorting speech signals under speech quality assessment. By using a distorted version of a speech signal, it is possible to compensate for different phonetic contents, different individual speakers and different speaking styles when assessing speech quality. The amount of degradation in the objective speech quality assessment by distorting the speech signal is maintained similarly for different speech signals, especially when the amount of distortion of the distorted version of speech signal is severe. Objective speech quality assessment for the distorted speech signal and the original undistorted speech signal are compared to obtain a speech quality assessment compensated for utterance dependent articulation.

### FIELD OF THE INVENTION

The present invention relates generally to communications systems and, in particular, to speech quality assessment.

### BACKGROUND OF THE RELATED ART

Performance of a wireless communication system can be measured, among other things, in terms of speech quality. In the current art, there are two techniques of speech quality assessment. The first technique is a subjective technique (hereinafter referred to as “subjective speech quality assessment”). In subjective speech quality assessment, human listeners are typically used to rate the speech quality of processed speech, wherein processed speech is a transmitted speech signal which has been processed at the receiver. This technique is subjective because it is based on the perception of the individual human, and human assessment of speech quality by native listeners, i.e., people that speak the language of the speech material being presented or listened, typically takes into account language effects. Studies have shown that a listener's knowledge of language affects the scores in subjective listening tests. Scores given by native listeners were lower in subjective listening tests compared to scores given by non-native listeners when language information in speech is defect, i.e., mute. In a normal telephone conversation, the listener is often a native listener. Thus, it is preferable to use native listeners for subjective speech quality assessment in order to emulate typical conditions. Subjective speech quality assessment techniques provide a good assessment of speech quality but can be expensive and time consuming.

The second technique is an objective technique (hereinafter referred to as “objective speech quality assessment”). Objective speech quality assessment is not based on the perception of the individual human. Some objective speech quality assessment techniques are based on known source speech or reconstructed source speech estimated from processed speech. Other objective speech quality assessment techniques are not based on known source speech but on processed speech only. These latter techniques are referred to herein as “single-ended objective speech quality assessment techniques” and are often used when known source speech or reconstructed source speech are unavailable.

Current single-ended objective speech quality assessment techniques, however, do not provide as good an assessment of speech quality compared to subjective speech quality assessment techniques. One reason why current single-ended objective speech quality assessment techniques are not as good as subjective speech quality assessment techniques is because the former techniques do not account for language effects. Current single-ended objective speech quality assessment techniques have been unable to account for language effects in its speech assessment.

Accordingly, there exists a need for a single-ended objective speech quality assessment technique which accounts for language effects in assessing speech quality.

### SUMMARY OF THE INVENTION

The present invention is an objective speech quality assessment technique that reflects the impact of distortions which can dominate overall speech quality assessment by modeling the impact of such distortions on subjective speech quality assessment, thereby, accounting for language effects in objective speech quality assessment. In one embodiment, the objective speech quality assessment technique of the present invention comprises the steps of detecting distortions in an interval of speech activity using envelope information, and modifying an objective speech quality assessment value associated with the speech activity to reflect the impact of the distortions on subjective speech quality assessment. In one embodiment, the objective speech quality assessment technique also distinguish types of distortions, such as short bursts, abrupt stops and abrupt starts, and modifies the objective speech quality assessment values to reflect the different impacts of each type of distortion on subjective speech quality assessment.

### BRIEF DESCRIPTION OF THE DRAWINGS

The features, aspects, and advantages of the present invention will become better understood with regard to the following description, appended claims, and accompanying drawings where:

FIG. 1 depicts a flowchart illustrating an objective speech quality assessment technique accounting for language effects in accordance with one embodiment of the present invention;

FIG. 2 depicts a flowchart illustrating a voice activity detector (VAD) which detects voice activity by examining envelope information associated with the speech signal in accordance with one embodiment of the present invention;

FIG. 3 depicts an example VAD activity diagram illustrating intervals T and G of speech and non-speech activities, respectively;

FIG. 4 depicts a flowchart illustrating an embodiment for determining whether speech activity is a short burst or impulsive noise and for modifying objective speech frame quality assessment vₛ(m) when a short burst or impulsive noise is determined;

FIG. 5 depicts a flowchart illustrating an embodiment for determining whether speech activity has an abrupt stop or mute and for modifying objective speech frame quality assessment vₛ(m) when it is determined that such speech activity has an abrupt stop or mute; and

FIG. 6 depicts a flowchart illustrating an embodiment for determining whether speech activity has an abrupt start and for modifying objective speech frame quality assessment vₛ(m) when it is determined that such speech activity has an abrupt start.

### DETAILED DESCRIPTION

The present invention is an objective speech quality assessment technique that reflects the impact of distortions which can dominate overall speech quality assessment by modeling the impact of such distortions on subjective speech quality assessment, thereby, accounting for language effects in objective speech quality assessment.

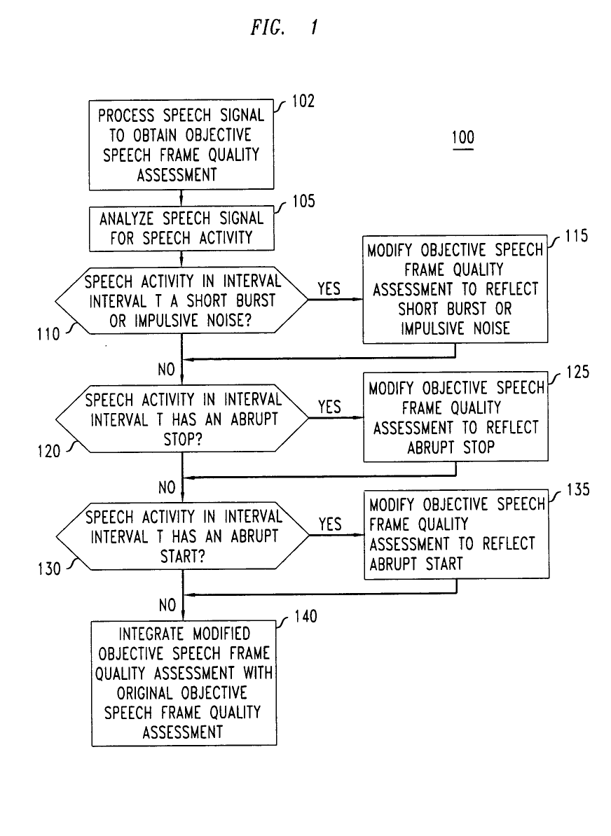

FIG. 1 depicts a flowchart 100 illustrating an objective speech quality assessment technique accounting language effects in accordance with one embodiment of the present invention. In step 102, speech signal s(n) is processed to determine objective speech frame quality assessment vₛ(m), i.e., objective quality of speech at frame m. In one embodiment, each frame m corresponds to a 64 ms interval. The manner of processing a speech signal s(n) to obtain objective speech frame quality assessment vₛ(m) (which do not account for language effects) is well-known in the art. One example of such processing is described in co-pending application Ser. No. 10/186,862, entitled “Compensation Of Utterance-Dependent Articulation For Speech Quality Assessment”, filed on Jul. 1, 2002 by inventor Doh-Suk Kim, attached herein as Appendix A.

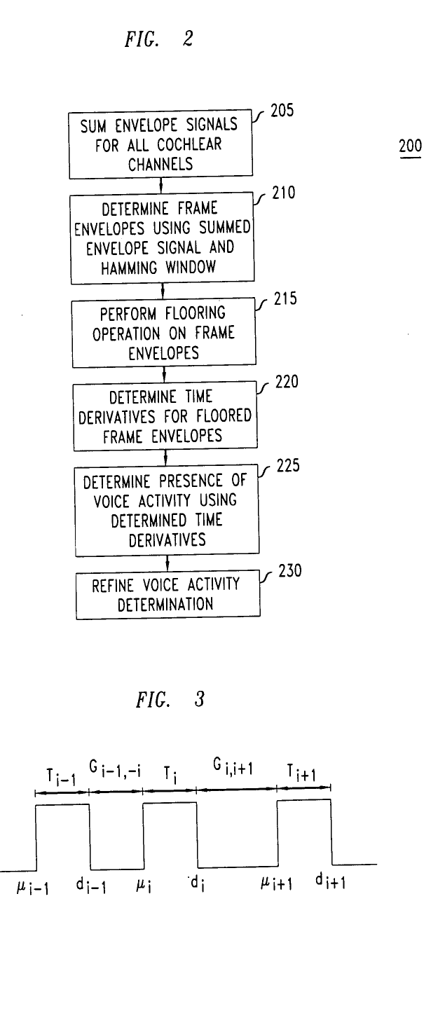

In step 105, speech signal s(n) is analyzed for voice activity by, for example, a voice activity detector (VAD). VADs are well-known in the art. FIG. 2 depicts a flowchart 200 illustrating a VAD which detects voice activity by examining envelope information associated with the speech signal in accordance with one embodiment of the present invention. In step 205, envelope signals γₖ(n) are summed up for all cochlear channels k to form summed envelope signal γ(n) in accordance with equation (1):

$$γ ( n ) = {\sum }_{k = 1}^{{N}_{cb}} {γ}_{k} ( n ) \qquad equation ( 1 )$$

where

$${γ}_{k} ( n ) = \sqrt{{s}_{k}^{2} ( n ) + {\hat{s}}_{k}^{2} ( n )} ,$$

n represents a time index, N_{cb} represents a total number of critical bands, sₖ(n) represents the output of speech signal s(n) through cochlear channel k, i.e., sₖ(n)=s(n)*hₖ(n), and ŝₖ(n) is the Hilbert transform of sₖ(n).

In step 210, a frame envelope e(l) is computed every 2 ms by multiplying summed envelope signal y(n) with a 4 ms Hamming window w(n) in accordance with equation (2):

$$e ( l ) = log [ {\sum }_{n = 0}^{31} {γ}^{( l )} ( n ) w ( n ) + 1 ] \qquad equation ( 2 )$$

where γ^{(l)}(n) is the 2 ms l-th frame signal of the summed envelope signal γ(n). It should be understood that the durations of the frame envelope e(l) and Hamming window w(n) are merely illustrative and that other durations are possible. In step 215, a flooring operation is applied to frame envelope e(l) in accordance with equation (3).

$$e ( l ) = \{ \begin{matrix}e ( l ) & if e ( l ) > 5 \\ 5 & otherwise\end{matrix} \qquad equation ( 3 )$$

In step 220, time derivative Δe(l) of floored frame envelope e(l) is obtained in accordance with equation (4).

$$Δ e ( l ) = \frac{{\sum }_{j = - 3}^{3} j e ( l - j )}{{\sum }_{j = - 3}^{3} {j}^{2}} \qquad equation ( 4 )$$

where −3≦j≦3.

In step 225, voice activity detection is performed in accordance with equation (5).

$$vad ( l ) = \{ \begin{matrix}1 & if e ( l ) > 5 \\ 0 & otherwise\end{matrix} \qquad equation ( 5 )$$

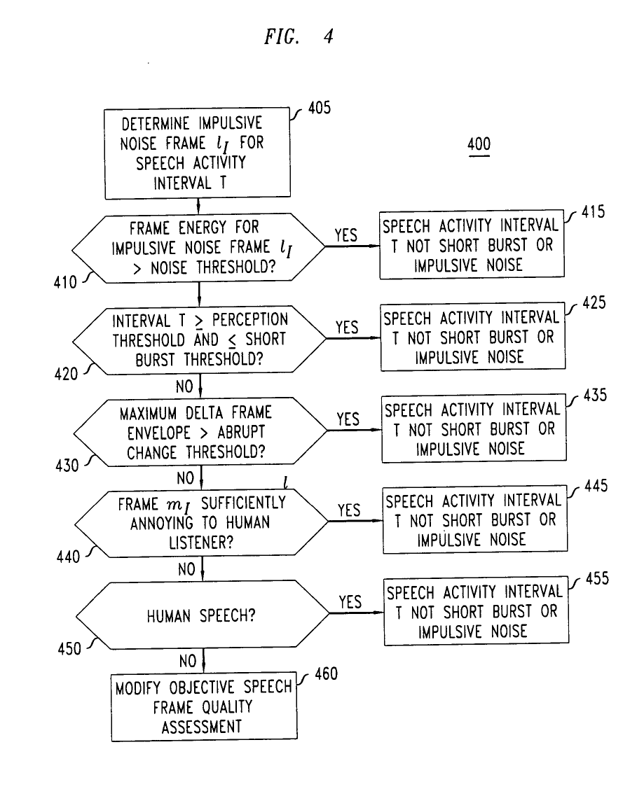

In step 230, the result of equation (5), i.e., vad(l), can then be refined based on the duration of 1's and 0's in the output. For example, if the duration of 0's in vad(l) is shorter than 8 ms, then vad(l) shall be changed to 1's for that duration. Similarly, if the duration of 1's in vad(q) is shorter than 8 ms, the vad(l) shall be changed to 0's for that duration. FIG. 3 depicts an example VAD activity diagram 30 illustrating intervals T and G of speech and non-speech activities, respectively. It should be understood that speech activities associated with intervals T may include, for example, actual speech, data or noise.

Returning to flowchart 100 of FIG. 1, upon analyzing speech signal s(n) for speech activity, interval T is examined to determine whether the associated speech activity corresponds to a short burst or impulsive noise in step 110. If the speech activity in interval T is determined to be a short burst or impulsive noise, then objective speech frame quality assessment vₛ(m) is modified in step 115 to obtain a modified objective speech frame quality assessment [symbol] (m). The modified objective speech frame quality assessment [symbol] (m) accounts for the effects of short burst or impulsive noise by modeling or simulating the impact of short bursts or impulsive noise on subjective speech quality assessment.

From step 115 of if in step 110 the speech activity in interval T is not determined to be a short burst or impulsive noise, then flowchart 100 proceeds to step 120 where the speech activity in interval T is examined to determine whether it has an abrupt stop or mute. If the speech activity in interval T is determined to have an abrupt stop or mute, then objective speech frame quality assessment vₛ(m) is modified in step 125 to obtain a modified objective speech frame quality assessment [symbol] (m). The modified objective speech frame quality assessment [symbol] (m) accounts for the effects of the abrupt stop or mute by modeling or simulating the impact of an abrupt stop or mute and subsequent release on subjective speech quality assessment.

From step 125 or if in step 120 the speech activity in interval T is not determined to have an abrupt stop or mute, then flowchart 100 proceeds to step 130 where the speech activity in interval T is examined to determine whether it has an abrupt start. If the speech activity in interval T is determined to have an abrupt start, then objective speech frame quality assessment vₛ(m) is modified in step 135 to obtain a modified objective speech frame quality assessment [symbol] (m). The objective speech frame quality assessment vₛ(m) accounts for the effects of the abrupt start by modeling or simulating the impact of an abrupt start on subjective speech quality assessment. From step 135 or if in step 130 the speech activity in interval T is not determined to have an abrupt start, then flowchart 100 proceeds to step 145 where the results of modifications to objective speech frame quality assessment vₛ(m), if any, are integrated into the original objective speech frame quality assessment vₛ(m) of step 102.

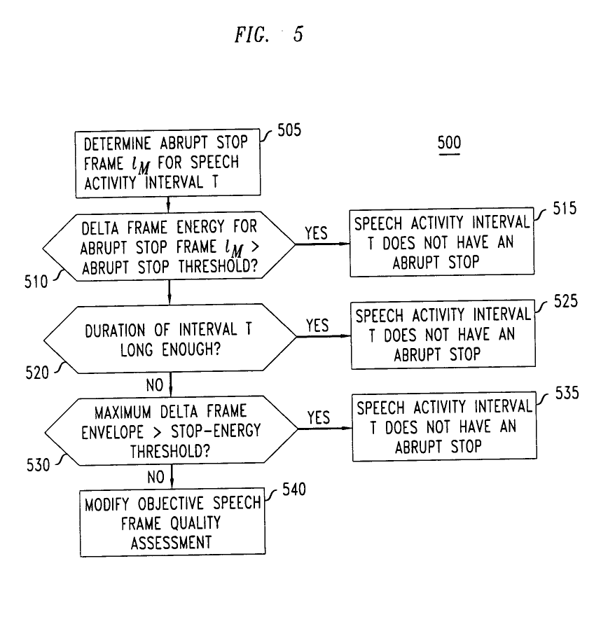

Techniques for determining whether speech activity is a short burst (or impulsive noise) or has an abrupt stop (or mute) or an abrupt start, i.e., steps 110, 120 and 130, along with techniques for modifying objective speech frame quality assessment vₛ(m), i.e., steps 115, 125 and 135, in accordance with one embodiment of the invention will now be described. FIG. 4 depicts a flowchart 400 illustrating an embodiment for determining whether speech activity is a short burst or impulsive noise and for modifying objective speech frame quality assessment vₛ(m) when a short burst or impulsive noise is determined. In step 405, an impulsive noise frame l_{I} is determined by finding a frame l in interval Tᵢ where frame envelope e(l) is maximum in accordance, for example, with equation (6):

$${l}_{I} = arg {max}_{{u}_{i} \leq l \leq {d}_{i}} e ( l ) \qquad equation ( 6 )$$

where uᵢ and dᵢ represents frames l at the beginning and end of interval Tᵢ, respectively. In step 410, frame envelope e(l_{I}) is compared to a listener threshold value indicating whether a human listener can consider the corresponding frame l_{I} as annoying short burst. In one embodiment, the listener threshold value is 8—that is, in step 410, e(l_{I}) is checked to determine whether it is greater than 8. If frame envelope e(l_{I}) is not greater than the listener threshold value, then in step 415 the speech activity is determined not to be a short burst or impulsive noise.

If frame envelope e(l_{I}) is greater than the listener threshold value, then in step 420 the duration of interval Tᵢ is checked to determine whether it satisfies both a short burst threshold value and a perception threshold value. That is, interval Tᵢ is being checked to determine whether interval Tᵢ is not too short to be perceived by a human listener and not too long to be categorized as a short burst. In one embodiment, if the duration of interval Tᵢ is greater than or equal to 28 ms and less than or equal to 60 ms, i.e., 28≦Tᵢ≦60, then both of the threshold values of step 420 are satisfied. Otherwise the threshold values of step 420 are not satisfied. If the threshold values of step 420 are not satisfied, then in step 425 the speech activity is determined not to be a short burst or impulsive noise.

If the threshold values of step 420 are satisfied, then in step 430 a maximum delta frame envelope Δe(l) is determined from the frame envelopes e(l) in the one or more frames prior to the beginning of interval Tᵢ through the first one or more frames of interval Tᵢ and subsequently compared to an abrupt change threshold value, such as 0.25. The abrupt change threshold value representing a criteria for identifying an abrupt change in the frame envelope. In one embodiment, a maximum delta frame envelope Δe(l) is determined from frame envelope e(uᵢ−1), i.e., frame envelope immediately preceding interval Tᵢ, through the frame envelope e(uᵢ+5), i.e., fifth frame envelope in interval Tᵢ, and compared to a threshold value of 0.25—that is, in step 430, it is checked to determine whether equation (7) is satisfied:

$${max}_{{u}_{i} - 1 \leq l \leq {u}_{i} + 5} Δ e ( l ) > 0.25 \qquad equation ( 7 )$$

If the maximum delta frame envelope Δe(l) does not exceed the threshold value, then in step 435 the speech activity is determined not to be a short burst or impulsive noise.

If the maximum delta frame envelope Δe(l) does exceed the threshold value, then in step 440 it is determined whether frame m_{I} would be sufficiently annoying to a human listener, where m_{I} corresponds to the frame m which is impacted most by impulsive noise frame l_{I}. In one embodiment, step 440 is achieved by determining whether a ratio of objective speech frame quality assessment vₛ(m_{I}) to modulation noise reference unit v_{q}(m_{I}) exceeds a noise threshold value. Step 440 may be expressed, for example, using a noise threshold value of 1.1 and equation (8):

$$\frac{{v}_{s} ( {m}_{I} )}{{v}_{q} ( {m}_{I} )} < 1.1 \qquad equation ( 8 )$$

wherein if equation (8) is satisfied, it would be determined that frame m_{I} has sufficient annoyance to a human listener. If it is determined that objective speech frame quality assessment vₛ(m_{I}) would be sufficiently annoying to a human listener, then in step 445 the speech activity is determined not to be a short burst or impulsive noise.

If it is determined that objective speech frame quality assessment vₛ(m_{I}) would not be sufficiently annoying to a human listener, then in step 450 conditions related to the durations of intervals G_{i-1,i}, G_{i,i+1}, Tᵢ₋₁ and/or Tᵢ₊₁ satisfying certain minimum or maximum duration threshold values are checked to verify that it belongs to human speech. In one embodiment, the conditions of step 450 are expressed as equations (9) and (10).

G_{i-1,i}<180 ms and G_{i,i+1}>40 ms and Tᵢ₋₁>50 ms equation (9)

G_{i-1,i}>40 ms and G_{i,i+1}<100 ms and Tᵢ₋₁>60 ms equation (10)

If any of these equations or conditions are satisfied, then in step 455 the speech activity is determined not to be a short burst or impulsive noise. Rather the speech activity is determined to be natural speech. It should be understood that the minimum and maximum duration threshold values used in equations (9) and (10) are merely illustrative and may be different.

If none of the conditions in step 450 are satisfied, then in step 460 objective speech frame quality assessment vₛ(m) is modified in accordance with equation 11:

$$( m ) = \frac{{v}_{s} ( m )}{1 + exp [ - 8.2 ( m - {m}_{I} ) / e ( {l}_{I} ) - 10 ]} \qquad equation ( 11 )$$

FIG. 5 depicts a flowchart 500 illustrating an embodiment for determining whether speech activity has an abrupt stop or mute and for modifying objective speech frame quality assessment vₛ(m) when it is determined that such speech activity has an abrupt stop or mute. In step 505, abrupt stop frame l_{M} is determined. The abrupt stop frame I_{M} is determined by first finding negative peaks of delta frame envelope Δe(l) in the speech activity using all frames l in interval Tᵢ. Delta frame envelope Δe(l) has a negative peak at l if Δe(l)<Δe(l+j) for 3≦j≦3. Upon finding the negative peaks, abrupt stop frame l_{M} is determined as the minimum of the negative peaks of delta frame envelopes Δe(l). In step 510, delta frame envelope Δe(l_{M}) is checked to determined whether an abrupt stop threshold value is satisfied. The abrupt stop threshold representing a criteria for determining whether there was sufficient negative change in frame envelope from one frame l to another frame l+1 to be considered an abrupt stop. In one embodiment, the abrupt stop threshold value is −0.56 and step 510 may be expressed as equation (12):

Δe(l_{M})<−0.56 equation (12)

If delta frame envelope Δe(l_{M}) does not satisfy the abrupt stop threshold value, then in step 515 the speech activity is determined not to have an abrupt stop or mute.

If delta frame envelope Δe(l_{M}) does satisfy the abrupt stop threshold value, then in step 520 interval Tᵢ is checked to determine if the speech activity is of sufficient duration, e.g., longer than a short burst. In one embodiment, the duration of interval Tᵢ is checked to see if it exceeds the duration threshold value, e.g., 60 ms. That is, if Tᵢ<60 ms, then the speech activity associated with interval Tᵢ is not of sufficient duration. If the speech activity is considered not of sufficient duration, then in step 525 the speech activity is determined not to have an abrupt stop or mute.

If the speech activity is considered of sufficient duration, then in step 530 a maximum frame envelope e(l) is determined for one or more frames prior to frame l_{M} through frame l_{M} or beyond and subsequently compared against a stop-energy threshold value. The stop-energy threshold value representing a criteria for determining whether a frame envelope has sufficient energy prior to muting. In one embodiment, maximum frame envelope e(l) is determined for frames l_{M}−⁷ through l_{M} and compared to a stop-energy threshold value of 9.5,

$${max}_{{l}_{m} - 7 \leq l \leq {l}_{m}} e ( l ) > 9.5 .$$

If the maximum frame envelope e(l) does not satisfy the stop-energy threshold value, then in step 535 the speech activity is determined not to have an abrupt stop or mute.

If the maximum frame envelope e(l) does satisfy the stop-energy threshold value, then objective speech frame quality assessment vₛ(m) is modified in accordance with equation 13 for several frames m, such as m_{M}, . . . , m_{M}+6:

$$( m ) = \vert Δ e ( {l}_{M} ) \vert [ \frac{6}{1 + exp [ - 2 ( m - {m}_{M} - 3 ]} - 6 ] \qquad equation ( 13 )$$

where m_{M} corresponds to the frame m which is impacted most by abrupt stop frame l_{M}.

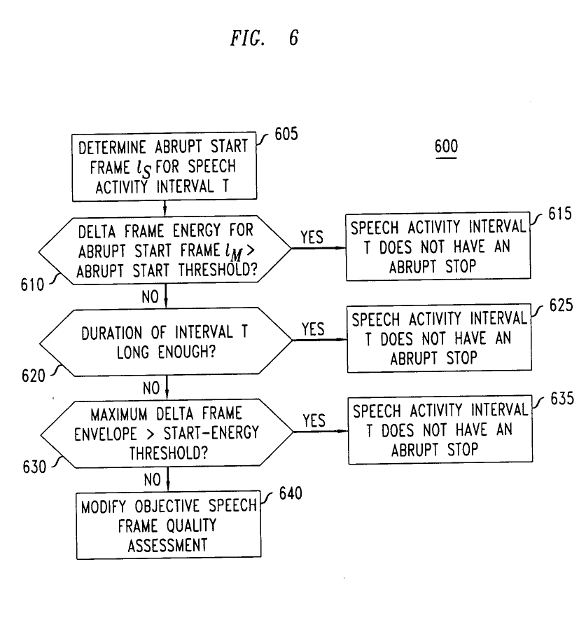

FIG. 6 depicts a flowchart 600 illustrating an embodiment for determining whether speech activity has an abrupt start and for modifying objective speech frame quality assessment vₛ(m) when it is determined that such speech activity has an abrupt start. In step 605, abrupt start frame l_{S} is determined. The abrupt start frame l_{S} is determined by first finding positive peaks of delta frame envelope Δe(l) in the speech activity using all frames l in interval Tᵢ. Delta frame envelope Δe(l) has a positive peak at l if Δe(l)>Δe(l+j) for 3≦j≦3. Upon finding the positive peaks, abrupt start frame l_{S} is determined as the maximum of the positive peaks of delta frame envelopes Δe(q). In step 610, delta frame envelope Δ(l_{S}) is checked to determined whether an abrupt start threshold value is satisfied. The abrupt start threshold representing a criteria for determining whether there was sufficient positive change in frame envelope from one frame l to another frame l+1 to be considered an abrupt start. In one embodiment, the abrupt stop threshold value is 0.9 and step 610 may be expressed as equation (14):

Δe(l_{S})>0.9 equation (4)

If delta frame envelope Δe(l_{S}) does not satisfy the abrupt start threshold value, then in step 615 the speech activity is determined not to have an abrupt start.

If delta frame envelope Δe(l_{S}) does satisfy the abrupt start threshold value, then in step 620 interval Tᵢ is checked to determined if the speech activity is of sufficient duration, e.g., longer than a short burst. In one embodiment, the duration of interval Tᵢ is checked to see if it exceeds the short burst threshold value, e.g., 60 ms. That is, if Tᵢ<60 ms, then the speech activity associated with interval Tᵢ is not of sufficient duration. If the speech activity is not of sufficient duration, then in step 625 the speech activity is determined not to have an abrupt start.

If the speech activity is of sufficient duration, then in step 630 a maximum frame envelope e(l) is determined for frame l_{S} or prior through one or more frames after frame l_{S} and subsequently compared against a start-energy threshold value. The start-energy threshold value representing a criteria for determining whether a frame envelope has sufficient energy. In one embodiment, maximum frame envelope e(7) is determined for frames l_{S} through l_{S}+7 and compared to a start-energy threshold value of 12, i.e.,

$${max}_{{l}_{S} \leq l \leq {l}_{S} + 7} e ( l ) < 12.$$

If the maximum frame envelope e(l) does not satisfy the start-energy threshold value, then in step 635 the speech activity is determined not to have an abrupt start.

If the maximum frame envelope e(l) does satisfy the start-energy threshold value, then objective speech frame quality assessment vₛ(m) is modified in accordance with equation 16 for several frames m, such as m_{M}, . . . , m_{M}+6:

$$( m ) = \frac{{v}_{s} ( m )}{1 + exp [ - 0.4 ( m - {m}_{S} ) / Δ e ( {l}_{S} ) - 10 ]} \qquad equation ( 16 )$$

where m_{S} corresponds to the frame m which is impacted most by abrupt start frame l_{S}. It should be understood that the values used in equations (11), (13) and (16) were derived empirically. Other values are possible. Thus, the present invention should not be limited to those specific values.

Note that upon determining modified objective speech frame quality assessment [symbol] (m), the integration performed in step 145 may be achieved using equation (17):

vₛ(m)=min(v_{s,I}(m), v_{s,M}(m), v_{s,S}(m)) equation (17)

where v_{s,I}(m), v_{s,M}(m) and v_{s,S}(m) correspond to the modified objective speech frame quality assessment [symbol] (m) of equations 11, 13 and 16, respectively.

Although the present invention has been described in considerable detail with reference to certain embodiments, other versions are possible. For example, the orders of the steps in the flowcharts may be re-arranged, or some steps (or criteria) may be deleted from or added to the flowcharts. Therefore, the spirit and scope of the present invention should not be limited to the description of the embodiments contained herein. It should also be understood to those skilled in the art that the present invention may be implemented either as hardware or software incorporated into some type of processor.

### FIELD OF THE INVENTION

The present invention relates generally to communications systems and, in particular, to speech quality assessment.

### BACKGROUND OF THE RELATED ART

Performance of a wireless communication system can be measured, among other things, in terms of speech quality. In the current art, there are two techniques of speech quality assessment. The first technique is a subjective technique (hereinafter referred to as “subjective speech quality assessment”). In subjective speech quality assessment, human listeners are used to rate the speech quality of processed speech, wherein processed speech is a transmitted speech signal which has been processed at the receiver. This technique is subjective because it is based on the perception of the individual human, and human assessment of speech quality typically takes into account phonetic contents, speaking styles or individual speaker differences. Subjective speech quality assessment can be expensive and time consuming.

The second technique is an objective technique (hereinafter referred to as “objective speech quality assessment”). Objective speech quality assessment is not based on the perception of the individual human. Most objective speech quality assessment techniques are based on known source speech or reconstructed source speech estimated from processed speech. However, these objective techniques do not account for phonetic contents, speaking styles or individual speaker differences.

Accordingly, there exists a need for assessing speech quality objectively which takes into account phonetic contents, speaking styles or individual speaker differences.

### SUMMARY OF THE INVENTION

The present invention is a method for objective speech quality assessment that accounts for phonetic contents, speaking styles or individual speaker differences by distorting speech signals under speech quality assessment. By using a distorted version of a speech signal, it is possible to compensate for different phonetic contents, different individual speakers and different speaking styles when assessing speech quality. The amount of degradation in the objective speech quality assessment by distorting the speech signal is maintained similarly for different speech signals, especially when the amount of distortion of the distorted version of speech signal is severe. Objective speech quality assessment for the distorted speech signal and the original undistorted speech signal are compared to obtain a speech quality assessment compensated for utterance dependent articulation. In one embodiment, the comparison corresponds to a difference between the objective speech quality assessments for the distorted and undistorted speech signals.

### BRIEF DESCRIPTION OF THE DRAWINGS

The features, aspects, and advantages of the present invention will become better understood with regard to the following description, appended claims, and accompanying drawings where:

FIG. 1 depicts an objective speech quality assessment arrangement which compensates for utterance dependent articulation in accordance with the present invention;

FIG. 2 depicts an embodiment of an objective speech quality assessment module employing an auditory-articulatory analysis module in accordance with the present invention.;

FIG. 3 depicts a flowchart for processing, in an articulatory analysis module, the plurality of envelopes aᵢ(t) in accordance with one embodiment of the invention; and

FIG. 4 depicts an example illustrating a modulation spectrum Aᵢ(m,f) in terms of power versus frequency.

### DETAILED DESCRIPTION

The present invention is a method for objective speech quality assessment that accounts for phonetic contents, speaking styles or individual speaker differences by distorting processed speech. Objective speech quality assessment tend to yield different values for different speech signals which have same subjective speech quality scores. The reason these values differ is because of different distributions of spectral contents in the modulation spectral domain. By using a distorted version of a processed speech signal, it is possible to compensate for different phonetic contents, different individual speakers and different speaking styles. The amount of degradation in the objective speech quality assessment by distorting the speech signal is maintained similarly for different speech signals, especially when the distortion is severe. Objective speech quality assessment for the distorted speech signal and the original undistorted speech signal are compared to obtain a speech quality assessment compensated for utterance dependent articulation.

FIG. 1 depicts an objective speech quality assessment arrangement 10 which compensates for utterance dependent articulation in accordance with the present invention. Objective speech quality assessment arrangement 10 comprises a plurality of objective speech quality assessment modules 12, 14, a distortion module 16 and a compensation utterance-specific bias module 18. Speech signal s(t) is provided as inputs to distortion module 16 and objective speech quality assessment module 12. In distortion module 16, speech signal s(t) is distorted to produce a modulated noise reference unit (MNRU) speech signal s′(t). In other words, distortion module 16 produces a noisy version of input signal s(t). MNRU speech signal s′(t) is then provided as input to objective speech quality assessment module 14.

In objective speech quality assessment modules 12, 14, speech signal s(t) and MNRU speech signal s′(t) are processed to obtain objective speech quality assessments SQ(s(t) and SQ(s′(t)). Objective speech quality assessment modules 12, 14 are essentially identical in terms of the type of processing performed to any input speech signals. That is, if both objective speech quality assessment modules 12, 14 receive the same input speech signal, the output signals of both modules 12, 14 would be approximately identical. Note that, in other embodiments, objective speech quality assessment modules 12, 14 may process speech signals s(t) and s′(t) in a manner different from each other. Objective speech quality assessment modules are well-known in the art. An example of such a module will be described later herein.

Objective speech quality assessments SQ(s(t) and SQ(s′(t)) are then compared to obtain speech quality assessment SQ_{compensated}, which compensates for utterance dependent articulation. In one embodiment, speech quality assessment SQ_{compensated} is determined using the difference between objective speech quality assessments SQ(s(t) and SQ(s′(t)). For example, SQ_{compensated} is equal to SQ(s(t) minus SQ(s′(t)), or vice-versa. In another embodiment, speech quality assessment SQ_{compensated} is determined based on a ratio between objective speech quality assessments SQ(s(t) and SQ(s′(t)). For example,

$${SQ}_{compensated} = \frac{SQ ( s ( t ) ) + μ}{SQ ( {s}^{′} ( t ) ) + μ} \qquad or \qquad {SQ}_{compensated} = \frac{SQ ( {s}^{′} ( t ) ) + μ}{SQ ( s ( t ) ) + μ}$$

where μ is a small constant value.

As mentioned earlier, objective speech quality assessment modules 12, 14 are well known in the art. FIG. 2 depicts an embodiment 20 of an objective speech quality assessment module 12, 14 employing an auditory-articulatory analysis module in accordance with the present invention. As shown in FIG. 2, objective quality assessment module 20 comprises of cochlear filterbank 22, envelope analysis module 24 and articulatory analysis module 26. In objective quality assessment module 20, speech signal s(t) is provided as input to cochlear filterbank 22. Cochlear filterbank 22 comprises a plurality of cochlear filters hᵢ(t) for processing speech signal s(t) in accordance with a first stage of a peripheral auditory system, where i=1, 2, . . . , N_{c} represents a particular cochlear filter channel and N_{c} denotes the total number of cochlear filter channels. Specifically, cochlear filterbank 22 filters speech signal s(t) to produce a plurality of critical band signals sᵢ(t), wherein critical band signal sᵢ(t) is equal to s(t)*hᵢ(t).

The plurality of critical band signals sᵢ(t) is provided as input to envelope analysis module 24. In envelope analysis module 24, the plurality of critical band signals sᵢ(t) is processed to obtain a plurality of envelopes aᵢ(t), wherein

$${a}_{i} ( t ) = \sqrt{{s}_{i}^{2} ( t ) + {\hat{s}}_{i}^{2} ( t )}$$

and ŝᵢ(t) is the Hilbert transform of sᵢ(t).

The plurality of envelopes aᵢ(t) is then provided as input to articulatory analysis module 26. In articulatory analysis module 26, the plurality of envelopes aᵢ(t) is processed to obtain a speech quality assessment for speech signal s(t). Specifically, articulatory analysis module 26 does a comparison of the power associated with signals generated from the human articulatory system (hereinafter referred to as “articulation power P_{A}(m,i)”) with the power associated with signals not generated from the human articulatory system (hereinafter referred to as “non-articulation power P_{NA}(m,i)”). Such comparison is then used to make a speech quality assessment.

FIG. 3 depicts a flowchart 300 for processing, in articulatory analysis module 26, the plurality of envelopes aᵢ(t) in accordance with one embodiment of the invention. In step 310, Fourier transform is performed on frame m of each of the plurality of envelopes aᵢ(t) to produce modulation spectrums Aᵢ(m,f), where f is frequency.

FIG. 4 depicts an example 40 illustrating modulation spectrum Aᵢ(m,f) in terms of power versus frequency. In example 40, articulation power P_{A}(m,i) is the power associated with frequencies 2˜12.5 Hz, and non-articulation power P_{NA}(m,i) is the power associated with frequencies greater than 12.5 Hz. Power P_{No}(m,i) associated with frequencies less than 2 Hz is the DC-component of frame m of critical band signal aᵢ(t). In this example, articulation power P_{A}(m,i) is chosen as the power associated with frequencies 2˜12.5 Hz based on the fact that the speed of human articulation is 2˜12.5 Hz, and the frequency ranges associated with articulation power P_{A}(m,i) and non-articulation power P_{NA}(m,i) (hereinafter referred to respectively as “articulation frequency range” and “non-articulation frequency range”) are adjacent, non-overlapping frequency ranges. It should be understood that, for purposes of this application, the term “articulation power P_{A}(m,i)” should not be limited to the frequency range of human articulation or the aforementioned frequency range 2˜12.5 Hz. Likewise, the term “non-articulation power P_{NA}(m,i)” should not be limited to frequency ranges greater than the frequency range associated with articulation power P_{A}(m,i). The non-articulation frequency range may or may not overlap with or be adjacent to the articulation frequency range. The non-articulation frequency range may also include frequencies less than the lowest frequency in the articulation frequency range, such as those associated with the DC-component of frame m of critical band signal aᵢ(t).

In step 320, for each modulation spectrum Aᵢ(m,f), articulatory analysis module 26 performs a comparison between articulation power P_{A}(m,i) and non-articulation power P_{NA}(m,i). In this embodiment of articulatory analysis module 26, the comparison between articulation power P_{A}(m,i) and non-articulation power P_{NA}(m,i) is an articulation-to-non-articulation ratio ANR (m,i). The ANR is defined by the following equation

$$ANR ( m , i ) = \frac{{P}_{A} ( m , i ) + ϵ}{{P}_{NA} ( m , i ) + ϵ} \qquad equation ( 1 )$$

where ε is some small constant value. Other comparisons between articulation power P_{A}(m,i) and non-articulation power P_{NA}(m,i) are possible. For example, the comparison may be the reciprocal of equation (1), or the comparison may be a difference between articulation power P_{A}(m,i) and non-articulation power P_{NA}(m,i). For ease of discussion, the embodiment of articulatory analysis module 26 depicted by flowchart 300 will be discussed with respect to the comparison using ANR(m,i) of equation (1). This should not, however, be construed to limit the present invention in any manner.

In step 330, ANR(m,i) is used to determine local speech quality LSQ(m) for frame m. Local speech quality LSQ(m) is determined using an aggregate of the articulation-to-non-articulation ratio ANR(m,i) across all channels i and a weighing factor R(m,i) based on the DC-component power P_{No}(m,i). Specifically, local speech quality LSQ(m) is determined using the following equation

$$\begin{matrix}LSQ ( m ) = log [ {\sum }_{i = 1}^{{N}_{c}} ANR ( m , i ) R ( m , i ) ] & equation ( 2 ) \\ where & \\ R ( m , i ) = \frac{log ( 1 + {P}_{No} ( m , i )}{{\sum }_{k = 1}^{Nc} log ( 1 + {P}_{No} ( m , k )} & equation ( 3 )\end{matrix}$$

and k is a frequency index.

In step 340, overall speech quality SQ for speech signal s(t) is determined using local speech quality LSQ(m) and a log power Pₛ(m) for frame m. Specifically, speech quality SQ is determined using the following equation

$$SQ = L {\{ {P}_{s} ( m ) LSQ ( m ) \}}_{m = 1}^{T} = {[ {\sum }_{{m = 1}_{{P}_{s} > {P}_{th}}}^{T} {P}_{s}^{λ} ( m ) {LSQ}^{λ} ( m ) ]}^{\frac{1}{λ}} \qquad equation ( 4 )$$

where

$${P}_{s} ( m ) = log [ {\sum }_{t \hat{I} m} {s}^{2} ( t ) ] ,$$

L is Lₚ-norm, T is the total number of frames in speech signal s(t), λ is any value, and Pₜₕ is a threshold for distinguishing between audible signals and silence. In one embodiment, λ is preferably an odd integer value.

The output of articulatory analysis module 26 is an assessment of speech quality SQ over all frames m. That is, speech quality SQ is a speech quality assessment for speech signal s(t).

Although the present invention has been described in considerable detail with reference to certain embodiments, other versions are possible. Therefore, the spirit and scope of the present invention should not be limited to the description of the embodiments contained herein.

I claim:

1. A method of assessing speech quality comprising the steps of:
determining a first and second speech quality assessment for a first and second speech signal, the first speech signal being a distorted version of the second speech signal; and
comparing the first and second speech qualities to obtain a compensated speech quality assessment.

2. The method of claim 1 comprising the additional steps of
prior to determining the first and second speech quality assessments, distorting the second speech signal to produce the first speech signal.

3. The method of claim 1, wherein the first and second speech qualities are assessed using an identical technique for objective speech quality assessment.

4. The method of claim 1, wherein the compensated speech quality assessment corresponds to a difference between the first and second speech qualities.

5. The method of claim 1, wherein the compensated speech quality assessment corresponds to a ratio between the first and second speech qualities.

6. The method of claim 1, wherein the first and second speech qualities are assessed using auditory-articulatory analysis.

7. The method of claim 1, wherein the step assessing the second or first speech quality comprises the steps of;
comparing articulation power and non-articulation power for the speech signal or distorted speech signal, wherein articulation and non-articulation powers are powers associated with articulation and non-articulation frequencies of the speech signal or distorted speech signal; and
and assessing the second or first speech quality based on the comparison.

8. The method of claim 7, wherein the articulation frequencies are approximately 2˜12.5 Hz.

9. The method of claim 7, wherein the articulation frequencies correspond approximately to a speed of human articulation.

10. The method of claim 7, wherein the non-articulation frequencies are approximately greater than the articulation frequencies.

11. The method of claim 7, wherein the comparison between the articulation power and non-articulation power is a ratio between the articulation power and non-articulation power.

12. The method of claim 10, wherein the ratio includes a denominator and numerator, the numerator including the articulation power and a small constant, the denominator including the non-articulation power plus the small constant.

13. The method of claim 7, wherein the comparison between the articulation power and non-articulation power is a difference between the articulation power and non-articulation power.

14. The method of claim 7, wherein the step of assessing the first or second speech quality includes the step of:
determining a local speech quality using the comparison.

15. The method of claim 7, wherein the local speech quality is further determined using a weighing factor based on a DC-component power.

16. The method of claim 9, wherein the first or second speech quality is determined using the local speech quality.

17. The method of claim 7, wherein the step of comparing articulation power and non-articulation power includes the step of:
performing a Fourier transform on each of a plurality of envelopes obtained from a plurality of critical band signals.

18. The method of claim 7, wherein the step of comparing articulation power and non-articulation power includes the step, of:
filtering the speech signal to obtain a plurality of critical band signals.

19. The method of claim 18, wherein the step of comparing articulation power and non-articulation power includes the step of:
performing an envelope analysis on the plurality of critical band signals to obtain a plurality of modulation spectrums.

20. The method of claim 18, wherein the step of comparing articulation power and non-articulation power includes the step of:
performing a Fourier transform on each of the plurality of modulation spectrums.
